(19) United States
(12) Patent Application Publication
(10) Pub. No.: US 2014/0358352 A1
(43) Pub. Date: Dec. 4, 2014

(54) VEHICLE SPEED CONTROL DEVICE AND VEHICLE INCLUDING SAME

(71) Applicants: Masaya Yamamoto, Kasugai-shi (JP); Jun Yasue, Toyota-shi (JP)

(72) Inventors: Masaya Yamamoto, Kasugai-shi (JP); Jun Yasue, Toyota-shi (JP)

(73) Assignees: DENSO CORPORATION, Kariya-shi, Aichi (JP); TOYOTA JIDOSHA KABUSHIKI KAISHA, Toyota-shi, Aichi (JP)

(21) Appl. No.: 14/373,486

(22) PCT Filed: Jan. 25, 2013
(86) PCT No.: PCT/JP2013/051600

§ 371 Date: Jul. 21, 2014

(30) Foreign Application Priority Data
Jan. 31, 2012 (JP) 2012-017958

(51) Int. Cl. B60L 15/20

(52) U.S. Cl. CPC B60L 15/20
USPC 701/22

(57) ABSTRACT

A vehicle speed control device includes: a traction battery; an electric motor that drives wheels of a vehicle to rotate; an inverter, connected to the traction battery via electrical paths and, converts electric power supplied by the traction battery to electric power for supply to the electric motor; and relays and provided on the electrical paths, wherein the vehicle speed control device, which performs a first judgment as to whether or not the traction battery is in a died state and, if it is in the died state, turns off the relays and, performs a second judgment as to whether or not the traction battery is in a battery just before died state, and if it is determined in the second judgment that the traction battery is in the battery just before died state, controls the electric motor to restrict vehicle speed to or below an SMR-openable vehicle speed.

### TECHNICAL FIELD

The present invention relates to vehicle speed control devices that control the vehicle speed of a vehicle, such as an electric vehicle including as a driving force source an electric motor that is driven by electric power from a traction battery, and relates also to vehicles including such a vehicle speed control device. The present invention relates especially to vehicle speed control technology when the traction battery is died.

### BACKGROUND ART

In a vehicle, such as an electric vehicle including as a driving force source an electric motor that is driven by electric power from a traction battery, the torque of the electric motor is restricted when the traction battery becomes died (reaches a died state), so that the vehicle can continue to travel in limp home mode even if the traction battery is too died for normal travel (see, for example, Patent Literature 1).

### CITATION LIST

### Patent Literature

### [Patent Literature 1] JP H10-191502 A

### SUMMARY OF INVENTION

### Technical Problem

Meanwhile, such a vehicle includes electrical devices (e.g., auxiliary equipment). There are equipped relays (e.g., system main relays (SMRs)) on the electrical paths that link the traction battery, the electric motor, and the electrical devices. The relays are desirably turned off (opened) quickly to protect the over discharging the traction battery.

If the relays are turned off when the vehicle is traveling at a high speed (high vehicle speed state), however, back electromotive force from the electric motor may damage the electrical devices.

Therefore, when the traction battery is died, the vehicle is desirably controlled to travel at a low speed (low vehicle speed state) that is below or equal to the vehicle speed at which the back electromotive force induced in the electric motor upon turning off the relays is restrained (SMR-openable vehicle speed), to prevent the electrical devices from being damaged.

The present invention, conceived in view of these problems, has an object to provide a vehicle speed control device capable of controlling the vehicle to travel at a sufficiently low speed (in a sufficiently low vehicle speed state) (i.e., in a low vehicle speed state that is below or equal to the SMR-openable vehicle speed) when the traction battery is died and also to provide a vehicle including the vehicle speed control device.

### Solution to Problem

A vehicle speed control device in accordance with the present invention, to address the problems, includes: a traction battery; an electric motor that drives wheels of a vehicle to rotate; a drive circuit, connected to the traction battery via electrical paths, that converts DC electric power supplied by the traction battery to AC electric power for supply to the electric motor; and relays provided on the electrical paths, wherein the vehicle speed control device, which performs a first judgment as to whether or not the traction battery is in a died state and which, if it is determined in the first judgment that the traction battery is in the died state, turns off the relays, performs a second judgment as to whether or not the traction battery is in a battery just before died state, and if it is determined in the second judgment that the traction battery is in the battery just before died state, controls the electric motor to restrict vehicle speed to a first predetermined vehicle speed or to a lower vehicle speed.

According to the above arrangement, if it is determined in the second judgment that the traction battery is in the battery just before died state, the electric motor is controlled so that the vehicle speed of the vehicle is restricted to or below the first predetermined vehicle speed. In other words, the vehicle speed is restricted to or below the first predetermined vehicle speed when the traction battery is in the battery just before died state. Therefore, the vehicle speed is already restricted to or below the first predetermined vehicle speed when the traction battery is died immediately after the battery just before died state.

In this configuration, the first predetermined vehicle speed is a vehicle speed (SMR-openable vehicle speed) at which the back electromotive force induced in the electric motor when the relays are turned off is restrained to such a level that the predetermined electrical devices connected to the electrical paths are prevented from being damaged.

In this manner, when the traction battery is died, the vehicle speed is already restricted to or below the first predetermined vehicle speed (SMR-openable vehicle speed). That enables the vehicle to be controlled to a sufficiently low vehicle speed state when the traction battery is died.

The vehicle speed control device in accordance with the present invention is the vehicle speed control device described above, wherein: the drive circuit has an electric power supply upper limit value setting as to an electric power that the drive circuit is capable of supplying to the electric motor; and the vehicle speed control device, if it is determined in the second judgment that the traction battery is in the battery just before died state, controls the electric motor to restrict vehicle speed to the first predetermined vehicle speed or to a lower speed by reducing the electric power supply upper limit value setting.

According to the above arrangement, the electric motor is controlled by reducing the electric power supply upper limit value setting so that the vehicle speed is restricted to or below the first predetermined vehicle speed. Therefore, the electric motor is controllable to restrict the vehicle speed when the traction battery is died to or below the first predetermined vehicle speed, by simply changing the electric power supply upper limit value setting (in other words, through a simple process).

The vehicle speed control device in accordance with the present invention is the vehicle speed control device described above, wherein: the electric motor has a torque upper limit value setting; and the vehicle speed control device, if it is determined in the second judgment that the traction battery is in the battery just before died state, controls the electric motor to restrict vehicle speed to the first predetermined vehicle speed or to a lower speed by reducing the torque upper limit value setting.

According to the above arrangement, the electric motor is controlled by reducing the torque upper limit value setting so that the vehicle speed becomes lower than or equal to the first predetermined vehicle speed. Therefore, the electric motor is controllable to restrict the vehicle speed when the traction battery is died to or below the first predetermined vehicle speed, by simply changing the torque upper limit value setting (in other words, through a simple process).

The vehicle speed control device in accordance with the present invention is the vehicle speed control device described above, further including a braking device that brakes the vehicle, wherein the vehicle speed control device, if it is determined in the second judgment that the traction battery is in the battery just before died state, controls the electric motor to restrict vehicle speed to the first predetermined vehicle speed or to a lower speed by the braking device braking the vehicle.

According to the above arrangement, the electric motor is controlled to restrict the vehicle speed to or below the first predetermined vehicle speed, by the braking device braking the vehicle. Therefore, the electric motor is controllable to restrict the vehicle speed when the traction battery is died to or below the first predetermined vehicle speed, using a braking device installed in the vehicle as a standard component (in other words, without installing an additional device).

The vehicle speed control device in accordance with the present invention is the vehicle speed control device described above, wherein: the drive circuit has an electric power supply upper limit value setting as to an electric power that the drive circuit is capable of supplying to the electric motor; and the vehicle speed control device performs a third judgment as to whether or not the traction battery is in a predetermined low remaining charge state in which the traction battery has more remaining charge than in the battery just before died state, and if it is determined in the third judgment that the traction battery is in the predetermined low remaining charge state, controls the electric motor to restrict vehicle speed to a second predetermined vehicle speed or to a lower speed by reducing the electric power supply upper limit value setting, the second predetermined vehicle speed being higher than the first predetermined vehicle speed.

According to the above arrangement, if it is determined in the third judgment that the traction battery is in the predetermined low remaining charge state in which there is more remaining charge than in the battery just before died state, the electric motor is controlled to restrict the vehicle speed to or below the second predetermined vehicle speed, by reducing the electric power supply upper limit value setting. In other words, in this configuration, as the remaining charge of the traction battery sequentially decreases first to the predetermined low remaining charge state and then to the battery just before died state, the vehicle speed is reduced stepwise first to the second predetermined vehicle speed and then to the first predetermined vehicle speed. This stepwise reduction of the vehicle speed prevents the vehicle speed from being suddenly restricted to the first predetermined vehicle speed when the vehicle is traveling at a high speed and also prevents drivability (maneuverability, ride quality) from falling.

The vehicle speed control device in accordance with the present invention is the vehicle speed control device described above, wherein the vehicle speed control device performs a slow change process that slows down lowering of the electric power supply upper limit value setting or slows down lowering of the vehicle speed caused by the lowering of the electric power supply upper limit value setting.

According to the above arrangement, the slow change process is performed that slows down lowering of the electric power supply upper limit value setting or slows down lowering of the vehicle speed caused by the lowering of the electric power supply upper limit value setting. That prevents the vehicle speed from being rapidly changed and also prevents poor drivability (maneuverability, ride quality).

The vehicle speed control device in accordance with the present invention is the vehicle speed control device described above, wherein the vehicle speed control device performs a slow change process that slows down lowering of the torque upper limit value setting or slows down lowering of the vehicle speed caused by the lowering of the torque upper limit value setting.

According to the above arrangement, the slow change process is performed that slows down lowering of the torque upper limit value setting or slows down lowering of the vehicle speed caused by the lowering of the torque upper limit value setting. That prevents the vehicle speed from being rapidly changed and also prevents poor drivability (maneuverability, ride quality).

A vehicle including the vehicle speed control device in accordance with the present invention is the vehicle including the vehicle speed control device described above.

According to the above arrangement, a vehicle is provided that achieves the same effects as the vehicle speed control device.

### Advantageous Effects of Invention

An electric power control device for vehicles in accordance with the present invention is capable of controlling the vehicle to a sufficiently low vehicle speed state before the traction battery is died.

### BRIEF DESCRIPTION OF DRAWINGS

FIG. 1 is a structural schematic view of a vehicle including a vehicle speed control device in accordance with a first embodiment and a second embodiment of the present invention.

FIG. 2 is a flow chart depicting an operation of a vehicle speed control device in accordance with the first embodiment of the present invention.

FIG. 3 is an exemplary time chart depicting an operation of a vehicle speed control device in accordance with the first embodiment of the present invention.

FIG. 4 is a flow chart depicting an operation of a vehicle speed control device in accordance with the second embodiment of the present invention.

FIG. 5 is an exemplary time chart depicting an operation of a vehicle speed control device in accordance with the second embodiment of the present invention.

FIG. 6 is a structural schematic view of a vehicle including a vehicle speed control device in accordance with a third embodiment of the present invention.

FIG. 7 is a flow chart depicting an operation of a vehicle speed control device in accordance with the third embodiment of the present invention.

FIG. 8 is an exemplary time chart depicting an operation of a vehicle speed control device in accordance with the third embodiment of the present invention.

### DESCRIPTION OF EMBODIMENTS

The following will describe the present invention in detail by way of embodiments in reference to attached drawings.

### First Embodiment

### Structure

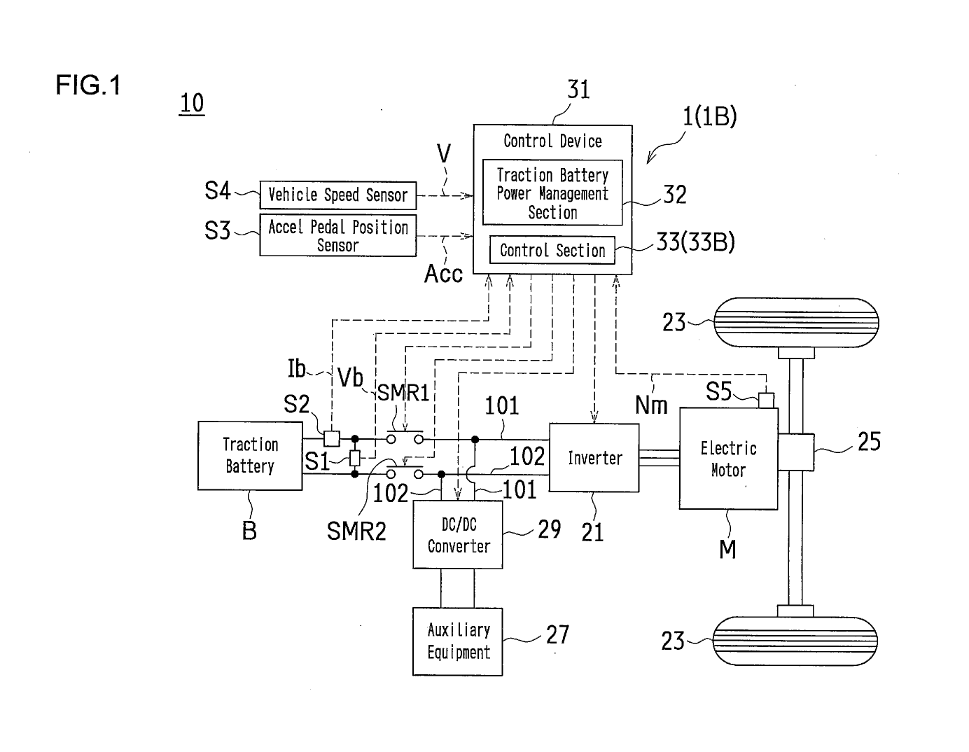

FIG. 1 is a structural schematic view of a vehicle including a vehicle speed control device in accordance with the first embodiment.

As illustrated in FIG. 1, a vehicle speed control device 1 in accordance with the first embodiment is provided in an electric vehicle including as a driving force source an electric motor M that is driven by electric power from a traction battery B (hereinafter, a “vehicle 10”). Under the control of the vehicle speed control device 1, the vehicle 10 is decelerated to a low vehicle speed state when the traction battery B has reached a battery just before died state. Hence, when the traction battery B has reached a died state, relays SMR1 and SMR2 can be opened with the vehicle 10 traveling in the low vehicle speed state.

As illustrated in FIG. 1, the vehicle 10 includes: the traction battery B; the electric motor M that functions as a driving force source and an electric power generator; an inverter (drive circuit) 21 that converts from three-phase AC to DC and vice versa between the traction battery B and the electric motor M; a decelerator 25 that drives drive wheels (wheels) 23 to rotate by the driving force generated by the electric motor M; auxiliary equipment 27, such as an air conditioner; a DC/DC converter 29 that supplies the electric power of the traction battery B to the auxiliary equipment 27; various vehicle sensors S1 to S5 that detect information related to the operation status of the vehicle 10; and a control device 31 that controls, for example, the inverter 21 and the DC/DC converter 29 based on detections by the vehicle sensors S1 to S5.

The vehicle speed sensors include, for example, a voltage sensor S1, an electric current sensor S2, an accel pedal position sensor S3, a vehicle speed sensor S4, and an electric motor rotational speed sensor S5. The voltage sensor S1 detects the output voltage Vb of the traction battery B. The electric current sensor S2 detects the output current Ib of the traction battery B. The accel pedal position sensor S3 detects the depression level (that is, accel pedal opening angle) Acc of the accel pedal position sensor of the vehicle 10. The vehicle speed sensor S4 detects the vehicle speed V of the vehicle 10. The electric motor rotational speed sensor S5 detects the rotational speed Nm of the electric motor M.

The traction battery B is a rechargeable battery (e.g., high voltage rechargeable battery) and built around, for example, a lithium-ion battery or a nickel-hydrogen battery.

The voltage sensor S1, detecting the output voltage Vb of the traction battery B, is disposed between the cathode and anode of the traction battery B. The electric current sensor S1, detecting the output current Ib of the traction battery B, is disposed near the cathode or anode of the traction battery B (near the cathode in FIG. 1). The detected values Vb and Ib from the sensors S1 and S2 are supplied to the control device 31 for use in detecting the SOC (State of Charge) of the traction battery B.

The cathode and anode of the traction battery B are connected to a power supply line 101 and a ground line 102 via system main relays (hereinafter, “relays”) SMR1 and SMR2 respectively. In other words, the system main relays SMR1 and SMR2 are disposed respectively on the lines 101 and 102.

The traction battery B is connected to the DC/DC converter 29 and the inverter 21 via the power supply line 101 and the ground line 102. The inverter 21 is connected in series with the traction battery B. The DC/DC converter 29 is connected, for example, in parallel with the inverter 21. The inverter 21 is connected to the electric motor M. The DC/DC converter 29 is connected to the auxiliary equipment 27.

The inverter 21, converting from three-phase AC to DC and vice versa as mentioned earlier, is a publicly known inverter built around, for example, a power switching device (e.g., an IGBT). The inverter 21 carries out the conversion as the power switching device is controlled ON/OFF by a control signal from the control device 31.

The electric power supply from the inverter 21 to the electric motor M has an upper limit value setting (electric power supply upper limit value setting) Wout (in kW). The inverter 21 converts the DC electric power of the traction battery B to AC electric power for supply to the electric motor M under the control of the control device 31, without exceeding the electric power supply upper limit value setting Wout, thereby driving the rotation of the electric motor M.

The DC/DC converter 29 steps down the DC electric power supplied by the traction battery B to a voltage suited to the auxiliary equipment 27 for supply to the auxiliary equipment 27. The DC/DC converter 29 is a publicly known DC/DC converter built around a power switching device (e.g., an IGBT). The DC/DC converter 29 carries out the stepping-down as the power switching device is controlled ON/OFF by a control signal from the control device 31.

The electric motor M is composed of, for example, a three-phase synchronous AC motor. The electric motor M is driven for rotation by the inverter 21 converting the DC voltage supplied by the traction battery B to a three-phase AC voltage and applying it as a drive voltage to the electric motor M. The driving force generated by the rotation of the electric motor M is transmitted to the drive wheels 23 via the decelerator 25, which enables the vehicle 10 to travel.

The electric motor M also functions as an electric power generator when the vehicle 10 is in braking by the electric motor M, (as it's called “regenerative brake”). Specifically, the electric motor M is capable of generating three-phase AC electric power by the driving force input from the drive wheels 23 via the decelerator 25. The three-phase AC electric power generated by the electric motor M may be converted to DC electric power by the inverter 21 to charge the traction battery B.

The control device 31, controlling the inverter 21 and the DC/DC converter 29, includes a traction battery power management section 32 and a control section 33.

The traction battery power management section 32 detects the remaining SOC of the traction battery B based on the detected values Vb and Ib from the voltage sensor S1 and the electric current sensor S2 to monitor the remaining SOC of the traction battery B.

The traction battery power management section 32 determines, from a result of the detection of the remaining SOC of the traction battery B, whether or not the remaining SOC of the traction battery B is lower than or equal to a first remaining SOC1 (in other words, whether or not the traction battery B is in a low remaining charge state) (third judgment) and outputs a result of the judgment to the control section 33. The low remaining charge state is a state in which the remaining SOC of the traction battery B is higher than in the battery just before died state, but so low that the vehicle 10 is unable to travel a long distance, and lower than or equal to the first remaining SOC1.

The traction battery power management section 32 determines, from a result of the detection of the remaining SOC of the traction battery B, whether or not the remaining SOC of the traction battery B is lower than or equal to a second remaining SOC2 (in other words, whether or not the traction battery B is in the battery just before died state) (second judgment) and outputs a result of the judgment to the control section 33. The battery just before died state is a state in which the remaining SOC of the traction battery B is so low that if the vehicle 10 continues to travel as it is traveling now, the traction battery B can be soon died, and lower than or equal to the second remaining SOC2 (<SOC1).

The traction battery power management section 32 determines, from a result of the detection of the remaining SOC of the traction battery B, whether or not the remaining SOC of the traction battery B is lower than or equal to a third remaining SOC3 (in other words, whether or not the traction battery B is in the died state) (first judgment) and outputs a result of the judgment to the control section 33. The died state is a state in which the remaining SOC of the traction battery B is almost died, and lower than or equal to the third remaining SOC3 (<SOC2).

The control section 33 controls the ON/OFF of the relays SMR1 and SMR2 and the vehicle speed V of the vehicle 10 via the inverter 21 and the electric motor M according to the detected values Vb, Ib, Acc, V, and Nm from the vehicle sensors S1 to S5 and according also to results of judgments made by the traction battery power management section 32.

The control section 33 controls the electric motor M via the inverter 21 according to the accel pedal opening angle Acc and the vehicle speed V, to change the vehicle speed V of the vehicle 10 as determined from the driver's operation. In this embodiment, the control section 33 controls the driving of the electric motor M via the inverter 21 according to, for example, the accel pedal opening angle Ace and the vehicle speed V, without exceeding the electric power supply upper limit value setting Wout for the inverter 21, to change the vehicle speed V of the vehicle 10 as determined from the driver's operation.

To describe it in more detail, the control section 33 obtains a tentative request torque Tma from the accel pedal opening angle Acc and the vehicle speed V, obtains a rotational speed (corresponding rotational speed) Nma that corresponds to the obtained tentative request torque Tma from predetermined motor characteristics (i.e., torque/rotational speed relation) of the electric motor M, and multiplies the tentative request torque Tma by the corresponding rotational speed Nma to obtain a calculated motor output value Wm (=Tma×Nma) that corresponds to the tentative request torque Tma.

The control section 33 then determines whether or not the calculated motor output value Wm is lower than or equal to the electric power supply upper limit value setting Wout. If it is determined that the calculated motor output value Wm is lower than or equal to the electric power supply upper limit value setting Wout, the control section 33 designates the tentative request torque Tma as the request torque Tm. On the other hand, if it is determined that the calculated motor output value Wm is not lower than or equal to the electric power supply upper limit value setting Wout, the control section 33 obtains from the motor characteristics such a tentative request torque Tma and corresponding rotational speed Nma that the calculated motor output value Wm can be equal to the electric power supply upper limit value setting Wout, and designates the obtained tentative request torque Tma as a request torque Tm.

The control section 33 then sets a target torque Tm* equal to the designated request torque Tm (e.g., Tm*=Tm). The control section 33 controls the inverter 21 so that the electric motor M can be driven to rotate at the target torque Tm*, to change the vehicle speed V of the vehicle 10 as determined from the driver's operation without exceeding the electric power supply upper limit value setting Wout.

The control section 33 controls (increases/decreases) the electric power supply upper limit value setting Wout for the inverter 21 according to results of judgments made by the traction battery power management section 32. The control section 33, in this embodiment, controls (increases/decreases) the electric power supply upper limit value setting Wout by performing a slow change process (e.g., rate processing) that slows down changes of the electric power supply upper limit value setting Wout.

To describe it in more detail, if the electric power supply upper limit value setting Wout is to be increased/decreased from the current upper limit value (e.g., WoutA) to an upper limit value WoutB, the control section 33 obtains an upper limit value deviation ΔWout, or a difference obtained by subtracting an upper limit value WoutA from the upper limit value WoutB, and determines whether or not the upper limit value deviation ΔWout is lower than or equal to a first threshold ΔWout1 (>0) and higher than or equal to a second threshold ΔWout2 (<0). If it is determined that the upper limit value deviation ΔWout is in that range, the control section 33 increases/decreases the electric power supply upper limit value setting Wout from the current upper limit value WoutA to the upper limit value WoutB.

On the other hand, if it is determined that the upper limit value deviation ΔWout is higher than the first threshold ΔWout1, the control section 33, as the slow change process, increases the electric power supply upper limit value setting Wout to a value obtained by adding the first threshold ΔWout1 to the upper limit value WoutA, instead of increasing the electric power supply upper limit value setting Wout to the upper limit value WoutB. Meanwhile, if it is determined that the upper limit value deviation ΔWout is lower than the second threshold ΔWout2, the control section 33, as the slow change process, decreases the electric power supply upper limit value setting Wout to a value obtained by adding the second threshold ΔWout2 to the upper limit value WoutA, instead of decreasing the electric power supply upper limit value setting Wout to the upper limit value WoutB. The control section 33 repeats the process until the electric power supply upper limit value setting Wout becomes equal to the upper limit value WoutB. In this manner, the control section 33 slowly increases/decreases the electric power supply upper limit value setting Wout from the current upper limit value WoutA to the upper limit value WoutB.

The slow change process performed on the changes of the electric power supply upper limit value setting Wout prevents rapid decreases of the electric power supply upper limit value setting Wout. That prevents rapid decreases of the request torque Tm that would otherwise be caused by the rapid decreases of the electric power supply upper limit value setting Wout, which in turn prevents rapid changes of the vehicle speed V.

In this embodiment, the slow change process is performed only on the changes of the electric power supply upper limit value setting Wout, not on the changes of the request torque Tm. Alternatively, the slow change process may also be performed on the changes of the request torque Tm as in the following.

The control section 33 obtains a torque deviation ΔTm by subtracting the lastly obtained request torque Tm from the currently obtained request torque Tm and determines whether or not the torque deviation ΔTm is lower than or equal to a first threshold ΔTm1 (>0) and higher than or equal to a second threshold ΔTm2 (<0). If it is determined that the torque deviation ΔTm is in that range, the control section 33 sets a target torque Tm* equal to the currently obtained request torque Tm. On the other hand, if it is determined that the torque deviation ΔTm is higher than the first threshold ΔTm1, the control section 33, as the slow change process, sets the target torque Tm* to a value obtained by adding the first threshold ΔTm1 to the lastly obtained request torque Tm, in place of the currently obtained request torque Tm. Meanwhile, if it is determined that the torque deviation ΔTm is lower than the second threshold ΔTm1, the control section 33, as the slow change process, sets the target torque Tm* to a value obtained by adding the second threshold ΔT2 to the lastly obtained request torque Tm, in place of the currently obtained request torque Tm. The slow change process, performed on the changes of the request torque Tm in this manner, prevents rapid changes of the vehicle speed V.

Alternatively, in this embodiment, the slow change process may be performed only on the changes of the request torque Tm, and not on the changes of the electric power supply upper limit value setting Wout. Furthermore, the slow change process performed on the changes of the electric power supply upper limit value setting Wout may be simplified by using none of the thresholds ΔWout1 and ΔWout2, so as to gradually increase or decrease the electric power supply upper limit value setting Wout at all times. In addition, no slow change process may be performed on the changes of the request torque Tm or the changes of the electric power supply upper limit value setting Wout.

In this embodiment, the electric power supply upper limit value setting Wout is controlled (increased/decreased) to be equal to a first upper limit value Wout1 for normal travel, a second upper limit value Wout2 for battery (SOC) saving mode, or a third upper limit value Wout3 for the battery just before died state. The second upper limit value Wout2 is lower than the first upper limit value Wout1, and the third upper limit value Wout3, is lower than the second upper limit value Wout2.

The first upper limit value Wout1 is equal to a maximum electric power output of the traction battery B.

The second upper limit value Wout2 is an upper limit value by which the vehicle 10 is restricted to travel at a speed lower than or equal to a predetermined vehicle speed V1 (second predetermined vehicle speed) (battery saving mode) to prevent the traction battery B from being died (in other words, to reduce decreases of the remaining SOC of the traction battery B). The vehicle speed V1 is equal to, for example, a maximum vehicle speed as determined by the motor characteristics on an electric power that is lower than or equal to the upper limit value Wout2.

The third upper limit value Wout3 is an upper limit value by which the vehicle 10 is restricted to travel at a speed lower than or equal to a predetermined vehicle speed V2 (first predetermined vehicle speed) (<V1) (low vehicle speed state). The vehicle speed V2 is a predetermined vehicle speed (SMR-openable vehicle speed) at which the back electromotive force induced in the electric motor M when the relays SMR1 and SMR2 are opened is restrained to such a level that the electrical devices (e.g., auxiliary equipment 27) connected to the lines 101 and 102 are prevented from being damaged by the back electromotive force. The vehicle speed V2 is, for example, a maximum vehicle speed as determined by the motor characteristics on an electric power that is lower than or equal to the upper limit value Wout3.

To describe it in more detail, if the traction battery power management section 32 determines that the remaining SOC of the traction battery B is not lower than or equal to the first remaining SOC1, the control section 33 determines that there is no request for battery saving mode (i.e., travel mode by which the traction battery B is prevented from being died) for the vehicle 10 and controls the electric power supply upper limit value setting Wout to be equal to the first upper limit value Wout1. In this manner, the control section 33 controls the electric motor M via the inverter 21 without allowing electric power to exceed the first upper limit value Wout1. That enables normal travel of the vehicle 10 (since the upper limit value Wout1 is sufficiently high, the upper limit value Wout1 does not limit the vehicle speed V, allowing the vehicle to travel at a vehicle speed V as determined from the driver's operation).

On the other hand, if the traction battery power management section 32 determines that the remaining SOC of the traction battery B is lower than or equal to the first remaining SOC1, the control section 33 determines that there is a request for battery saving mode for the vehicle 10 and controls the electric power supply upper limit value setting Wout to be equal to the second upper limit value. In this manner, the control section 33 controls the electric motor M via the inverter 21 without allowing electric power to exceed the second upper limit value Wout2. That restricts the vehicle speed V to or below the vehicle speed V1, which in turn enables battery saving mode of the vehicle 10.

If the traction battery power management section 32 determines that the remaining SOC of the traction battery B is lower than or equal to the second remaining SOC2, the control section 33 determines that there is a request for restricting vehicle speed V preparing for the traction battery B being died (i.e., restriction of the vehicle speed V to a value that is lower than or equal to the SMR-openable vehicle speed V2) and controls the electric power supply upper limit value setting Wout to be equal to the third upper limit value Wout3. In this manner, the control section 33 controls the electric motor M via the inverter 21 without allowing electric power to exceed the third upper limit value Wout3. That restricts the vehicle 10 to travel in the low vehicle speed state (at a speed below or equal to the SMR-openable vehicle speed V2).

If the traction battery power management section 32 determines that the remaining SOC of the traction battery B is lower than or equal to the third remaining charge, the control section 33 determines that there is a request that the relays SMR1 and SMR2 be opened and controls the relays SMR1 and SMR2 to turn off. On the other hand, if the traction battery power management section 32 determines that the remaining SOC of the traction battery B is not lower than or equal to the third remaining charge, the control section 33 determines that there is no request that the relays SMR1 and SMR2 be opened and controls the relays SMR1 and SMR2 to turn on. This turn-off control prevents the traction battery B from being overdischarged in the died state.

When the vehicle 10 is in braking by the electric motor M, the control section 33 controls the inverter 21 to convert the three-phase AC electric power generated by the electric motor M to DC electric power to charge the traction battery B. The control section 33 also controls the DC/DC converter 29 to convert the DC electric power supplied by the traction battery B to a voltage suited to the auxiliary equipment 27 for supply to the auxiliary equipment 27.

The vehicle speed control device 1 in accordance with this embodiment includes at least the inverter 21, the control device 31, the electric motor M, the relays SMR1 and SMR2, the traction battery B, and the vehicle sensors S1 to S5.

### —Operation—

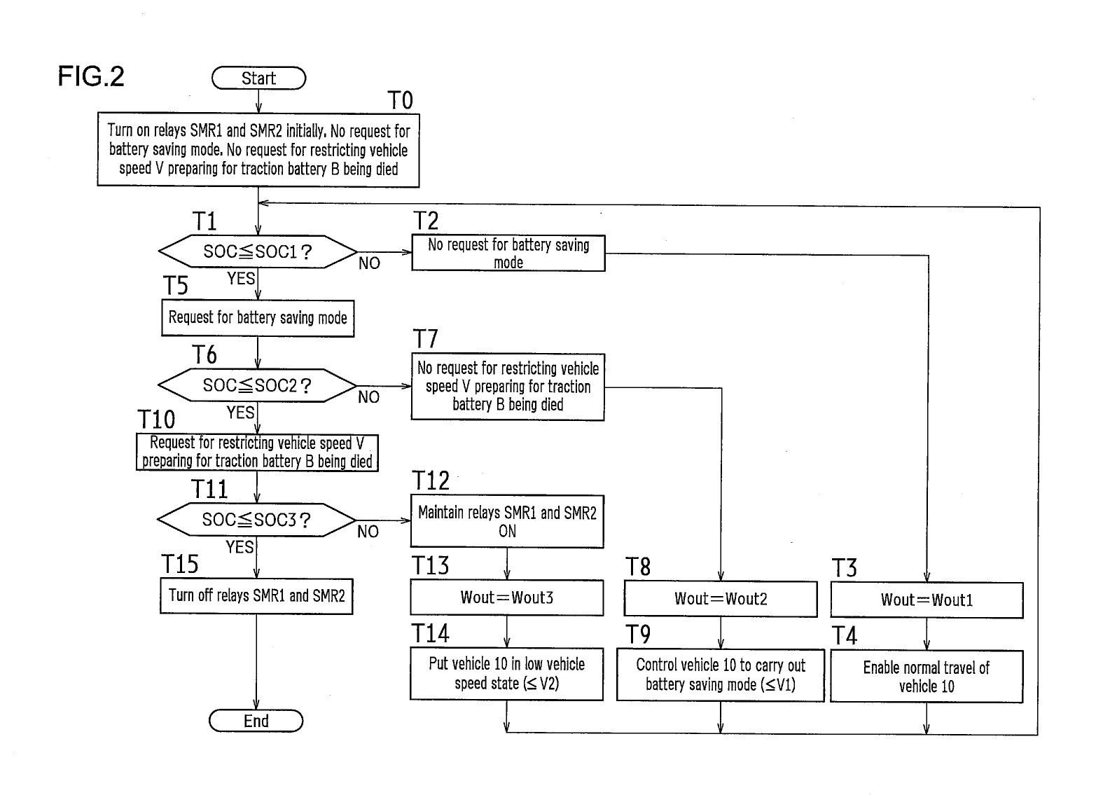

An operation of the vehicle speed control device 1 will be described in reference to FIG. 2. FIG. 2 is a flow chart depicting an operation of the vehicle speed control device 1.

In step T0, the control section 33 initially controls the relays SMR1 and SMR2 to turn on and determines that there is neither a request for battery saving mode nor a request for restricting vehicle speed V preparing for the traction battery B being died. The operation then proceeds to step T1.

In step T1, the control section 33 determines from a result of the detection made by the traction battery power management section 32 whether or not the remaining SOC of the traction battery B is lower than or equal to the first remaining SOC1 (in other words, whether or not the traction battery B is in the low remaining charge state).

If it is determined that the remaining SOC of the traction battery B is not lower than or equal to the first remaining SOC1, the operation proceeds to step T2 where the control section 33 determines that there is no request for battery saving mode. The operation then proceeds to step T3. On the other hand, if it is determined that the remaining SOC of the traction battery B is lower than or equal to the first remaining SOC1, the operation proceeds to step T5 where the control section 33 determines that there is a request for battery saving mode. The operation then proceeds to step T6.

In step T3, the control section 33 controls the electric power supply upper limit value setting Wout for the inverter 21 to be equal to the first upper limit value Wout1. Then, the control section 33, in step T4, controls the electric motor M via the inverter 21 without allowing electric power to exceed the electric power supply upper limit value setting Wout (=Wout1). This control enables normal travel of the vehicle 10 (in other words, the vehicle can travel practically with no speed limit). The operation then returns to step T1.

Meanwhile, in step T0, the control section 33 determines from a result of the detection made by the traction battery power management section 32 whether or not the remaining SOC of the traction battery B is lower than or equal to the second remaining SOC2 (in other words, whether or not the traction battery B is in the battery just before died state).

If it is determined that the remaining SOC of the traction battery B is not lower than or equal to the second remaining SOC2, the operation proceeds to step T7 where the control section 33 determines that there is no request for restricting vehicle speed V preparing for the traction battery B being died. The operation then proceeds to step T8. On the other hand, if it is determined that the remaining SOC of the traction battery B is lower than or equal to the second remaining SOC2, the operation proceeds to step T10 where the control section 33 determines that there is a request for restricting vehicle speed V preparing for the traction battery B being died. The operation then proceeds to step T11.

In step T8, the control section 33 controls the electric power supply upper limit value setting Wout for the inverter 21 to be equal to the second upper limit value Wout2. Then, the control section 33, in step T9, controls the electric motor M via the inverter 21 without allowing electric power to exceed the electric power supply upper limit value setting Wout (=Wout2). This control restricts the vehicle 10 to battery saving mode (in other words, the vehicle is restricted to travel at the vehicle speed V1 or at a lower speed). The operation then returns to step T1.

Meanwhile, in step T11, the control section 33 determines from a result of the detection made by the traction battery power management section 32 whether or not the remaining SOC of the traction battery B is lower than or equal to the third remaining SOC3 (in other words, whether or not the traction battery B is in the died state).

If it is determined that the remaining SOC of the traction battery B is not lower than or equal to the third remaining SOC3, the operation proceeds to step T12 where the control section 33 maintains the relays SMR1 and SMR2 ON. The operation then proceeds to step T13. On the other hand, if it is determined that the remaining SOC of the traction battery B is lower than or equal to the third remaining SOC3, the operation proceeds to step T15 where the control section 33 determines that the traction battery B has reached the died state and controls the relays SMR1 and SMR2 to turn off (i.e., open). This turn-off control prevents the traction battery B from being overdischarged in the died state. That ends the operation.

In step T13, the control section 33 controls the electric power supply upper limit value setting Wout for the inverter 21 to be equal to the third upper limit value Wout3. Then, the control section 33, in step T14, controls the electric motor M via the inverter 21 without allowing electric power to exceed the electric power supply upper limit value setting Wout (=Wout3) for the inverter 21. This control restricts the vehicle 10 to low vehicle speed travel (in other words, the vehicle is restricted to travel at the SMR-openable vehicle speed V2 or at a lower speed). The operation then returns to step T1.

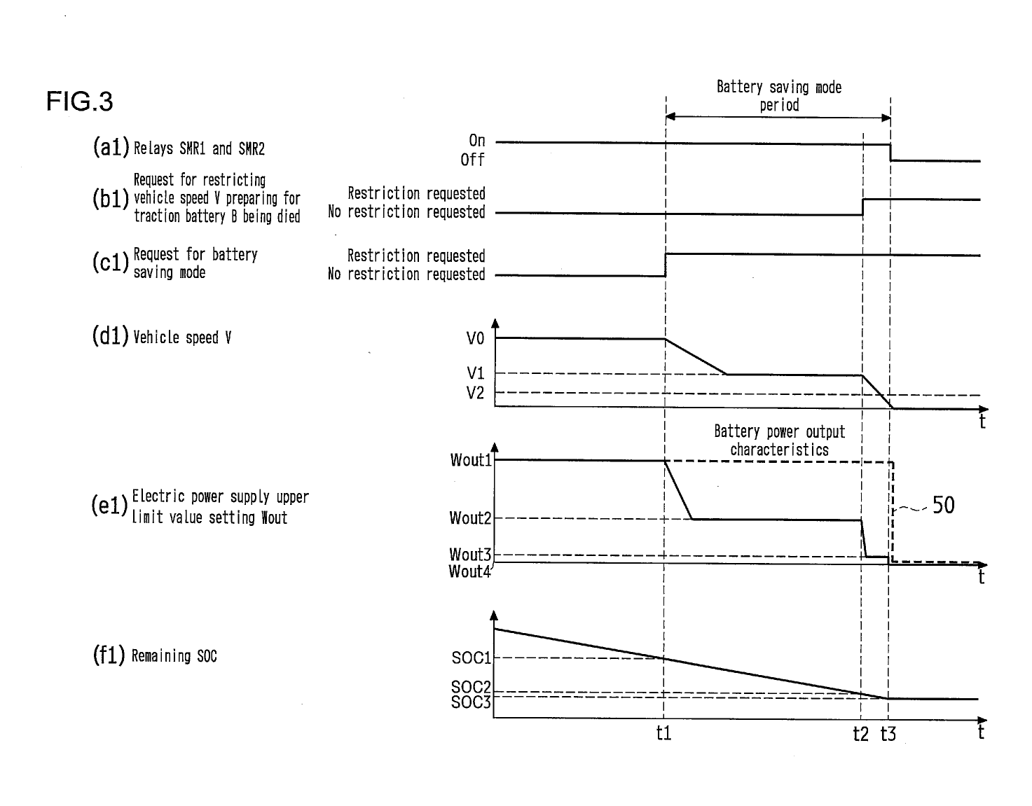

Next, the operation shown in FIG. 2 will be described as it is applied to the case shown in FIG. 3.

FIG. 3 is a time chart depicting temporal variations (f1) of the remaining SOC of the traction battery B and also depicting, for this exemplary case, ON/OFF timings (a1) for the relays SMR1 and SMR2, a timing (b1) for a request for restricting vehicle speed V preparing for the traction battery B being died, a timing (c1) for a request for battery saving mode, temporal variations (d1) of the vehicle speed V, and increase/decrease timings (e1) for the electric power supply upper limit value setting Wout.

In FIG. 3, as the vehicle 10 travels, the remaining SOC decreases to the first remaining SOC1 at time t1 (i.e., low remaining charge state), to the second remaining SOC2 at time t2 (i.e., battery just before died state), and to the third remaining SOC3 at time t3 (i.e., died state). The operation shown in FIG. 2 is applied to this exemplary case as follows.

During time t<t1, the remaining SOC of the traction battery B decreases within the limit, SOC1<SOC, and steps T0, T1, T2, T3, T4, and T1 in FIG. 2 are therefore repeated in this order. The control section 33 thus controls the relays SMR1 and SMR2 to turn on (step T0), determines that there is neither a request for battery saving mode nor a request for restricting vehicle speed V preparing for the traction battery B being died (steps T0 and T2), and controls the electric power supply upper limit value setting Wout to be equal to the first upper limit value Wout1 (step T3). The vehicle 10 hence carries out normal travel as determined from the driver's operation (step T4). FIG. 3 shows that the vehicle 10 is traveling, for example, at a vehicle speed V0 (normal travel) as determined from the driver's operation.

At time t=t1, the remaining SOC of the traction battery B reaches the first remaining SOC1, and the operation flow changes: steps T1, T5, T6, T7, T8, T9, and T1 in FIG. 2 are carried out in this order. The control section 33 thus determines that there is a request for battery saving mode (step T5), controls the electric power supply upper limit value setting Wout to be equal to the second upper limit value Wout2 (step T8), and controls the vehicle 10 to carry out battery saving mode at the vehicle speed V1 or at a lower speed (step T9). In this exemplary case, a slow change process is carried out to slowly control the electric power supply upper limit value setting Wout to be equal to the second upper limit value Wout2, which slowly restricts the vehicle speed V to the vehicle speed V1. During t1<t<t2, steps T1, T5, T6, T7, T8, T9, and T1 in FIG. 2 are repeated in this order. FIG. 3 shows that at t1<t<t2, the vehicle 10 travels at the vehicle speed V1 after the vehicle speed V reaches the vehicle speed V1.

At time t=t2, the remaining SOC of the traction battery B reaches the second remaining SOC2, and the operation flow changes: steps T1 T5, T6, T10, T11, T12, T13, T14, and T1 in FIG. 2 are carried out in this order. The control section 33 thus determines that there is a request for restricting vehicle speed V preparing for the traction battery B being died (step T10), controls the electric power supply upper limit value setting Wout to be equal to the third upper limit value Wout3 (step T13), and controls the vehicle 10 to travel in the low vehicle speed state at the SMR-openable vehicle speed V2 or at a lower speed (step T14). In this exemplary case, a slow change process is carried out to slowly control the electric voltage supply upper limit value setting Wout to be equal to the third upper limit value Wout3, which slowly restricts the vehicle speed V to or below the vehicle speed V2. During t2<t<t3, steps T1, T5, T6, T10, T11, T12, T13, T14, and T1 in FIG. 2 are repeated in this order. FIG. 3 shows that during t2<t<t3, the vehicle 10 travels at the vehicle speed V2 or at a lower speed after the vehicle speed V reaches the vehicle speed V2.

At time t=t3, the remaining SOC of the traction battery B reaches the third remaining SOC3, and the operation flow changes: steps T1, T5, T6, T10, T11, and T15 in FIG. 2 are carried out in this order. The control section 33 thus determines that the traction battery B is in the died state, therefore opening (turning off) the relays SMR1 and SMR2 (step T15), and controls the electric power supply upper limit value setting Wout to be equal to, for example, a fourth upper limit value Wout4 (<Wout3) which is a power-supply-suspending level. When the relays SMR1 and SMR2 are opened, the vehicle 10 is already in the low vehicle speed state at the SMR-openable vehicle speed V2 or at a lower speed (in other words, the electric motor M is being controlled so that the vehicle speed V is equal to a low vehicle speed that is below or equal to the SMR-openable vehicle speed V2). Therefore, the back electromotive force that occurs in the electric motor M when the relays SMR1 and SMR2 are opened is reduced. That in turn prevents the electrical devices (e.g., auxiliary equipment 27) connected to the lines 101 and 102 from being damaged by the back electromotive force induced in the electric motor M when the relays SMR1 and SMR2 are open.

The reference numeral 50 in FIG. 3 indicates a graphical representation of the power output characteristics of the traction battery B until the relays SMR1 and SMR2 are opened. As shown in the graph, the electric power output of the traction battery B falls rapidly after the traction battery B is died. In this embodiment, the vehicle speed V is restricted to or below the vehicle speed V2 by reducing the electric power supply upper limit value setting Wout to the second upper limit value Wout3 before the power output characteristics of the traction battery B decrease.

This heavy restriction of the electric power supply upper limit value setting Wout for the inverter 21 to the upper limit value Wout3 reduces the maximum value of the vehicle speed V. That in turn restricts the vehicle speed V to or below the SMR-openable vehicle speed V2 and prevents the electrical devices from being damaged when the relays are opened. In addition, since a slow change process is performed when the electric power supply upper limit value setting Wout is controlled (increased or decreased), drivability is prevented from decreasing.

### —Major Effects—

According to the vehicle speed control device 1 configured as above, if it is determined in the second judgment that the traction battery B is in the battery just before died state, the electric motor M is controlled so that the vehicle speed V of the vehicle 10 is restricted to or below the predetermined vehicle speed V2. In other words, because the vehicle speed V is restricted to or below the predetermined vehicle speed V2, starting when the traction battery B is in the battery just before died state, the vehicle speed V is already restricted to or below the predetermined vehicle speed V2 in the instance of the traction battery B died.

In this embodiment, the predetermined vehicle speed V2 is a vehicle speed (SMR-openable vehicle speed) at which the back electromotive force induced in the electric motor when the relays SMR1 and SMR2 are turned off is restrained to such a level that the predetermined electrical devices (e.g., auxiliary equipment 27) connected to the lines 101 and 102 are not damaged.

In this manner, when the traction battery B is died, the vehicle speed V is already restricted to lower than or equal to the predetermined vehicle speed V2 (SMR-openable vehicle speed). Therefore, when the traction battery B is died, the vehicle V is controllable to a sufficiently low vehicle speed state (in other words, the electric motor M is controllable so that the vehicle speed V is sufficiently low). This control restrains the back electromotive force induced in the electric motor by the relays SMR1 and SMR2 being opened (being controlled to turn off) when the traction battery B is died and prevents the predetermined electrical devices (e.g., auxiliary equipment 27) connected to the lines 101 and 102 from being damaged by the back electromotive force induced in the electric motor.

As the remaining SOC of the traction battery B changes first to the predetermined low remaining charge state and then to the battery just before died state, the vehicle speed V is reduced stepwise first to the predetermined vehicle speed V1 and then to the predetermined vehicle speed V2. This stepwise reduction of the vehicle speed V prevents the vehicle speed V from being suddenly restricted to the predetermined vehicle speed V2 when the vehicle is traveling at a high speed and also prevents poor drivability (maneuverability, ride quality).

By reducing the electric power supply upper limit value setting Wout, the electric motor M is controlled so that the vehicle speed V is restricted to or below the predetermined vehicle speed V2. Therefore, the electric motor M is controlled so that the vehicle speed V when the traction battery B is died can be restricted to or below the predetermined vehicle speed V2 by simply changing the electric power supply upper limit value setting Wout (in other words, through a simple process).

The slow change process is performed in reducing the electric power supply upper limit value setting Wout or in reducing the vehicle speed V after the reduction of the electric power supply upper limit value setting Wout, to slowly change the reduction of the electric power supply upper limit value setting Wout or the vehicle speed V. That prevents the vehicle speed V from rapidly changing and prevents poor drivability (maneuverability, ride quality). In this embodiment, the slow change process is performed on the reduction of the vehicle speed V by performing the slow change process on the changes of the request torque Tm.

This embodiment has so far assumed that the vehicle speed control device 1 is installed in an electric vehicle. Alternatively, the vehicle speed control device 1 may be installed in a hybrid car that uses, as a driving force source, a combination of an internal combustion engine (e.g., engine) and an electric motor (e.g., electric motor).

### Second Embodiment

In the first embodiment, the electric power supply upper limit value setting Wout for the inverter 21 is controlled to indirectly restrict the vehicle speed V of the vehicle 10 when there is a request for battery saving mode and when there is a request for restricting vehicle speed V preparing for the traction battery B being died. In this embodiment, the vehicle speed V of the vehicle 10 is directly restricted by controlling the request torque of the electric motor M when there is a request for battery saving mode and when there is a request for restricting vehicle speed V preparing for the traction battery B being died.

The following description will focus on differences from the first embodiment, using the same reference numerals for the same claim elements as in the first embodiment.

### —Structure—

FIG. 1 is a structural schematic view of a vehicle including a vehicle speed control device in accordance with a second embodiment.

The vehicle speed control device 1B in accordance with this embodiment includes a control section 33B (detailed below) replacing the control section 33 in the vehicle speed control device 1 in accordance with the first embodiment.

The control section 33B in accordance with this embodiment controls the vehicle speed V of the vehicle 10 to a vehicle speed as determined from the driver's operation by controlling the electric motor M via the inverter 21 based on the accel pedal opening angle Acc, vehicle speed V, etc.

To describe it in more detail, the control section 33B determines a tentative request torque Tma based on the accel pedal opening angle Acc and the vehicle speed V and determines whether or not the tentative request torque Tma is lower than or equal to a torque upper limit value Tmax. If it is determined that the tentative request torque Tma is not lower than or equal to the torque upper limit value Tmax, the control section 33B designates the torque upper limit value Tmax as the request torque Tm. On the other hand, if it is determined that the tentative request torque Tma is lower than or equal to the torque upper limit value Tmax, the control section 33B designates the tentative request torque Tma as the request torque Tm.

The control section 33B then obtains a torque deviation ΔT by subtracting the lastly obtained request torque Tm from the currently obtained request torque Tm and determines whether or not the torque deviation ΔT is lower than or equal to a first threshold ΔT1 (>0) and higher than or equal to a second threshold ΔT2 (<0). If it is determined that the torque deviation ΔT is in that range, the control section 33B sets a target torque Tm* equal to the currently obtained request torque Tm. On the other hand, if it is determined that the torque deviation ΔT is higher than or equal to the first threshold ΔT1, the control section 33B, as the slow change process, sets the target torque Tm* to a value obtained by adding the first threshold ΔT1 to the lastly obtained request torque Tm. On the other hand, if it is determined that the torque deviation ΔT is lower than or equal to the second threshold ΔT1, the control section 33B, as the slow change process, sets the target torque Tm* to a value obtained by adding the second threshold ΔT2 to the lastly obtained request torque Tm.

The control section 33B then controls the inverter 21 so that the electric motor M can be driven to rotate at the target torque Tm*, to change the vehicle speed V of the vehicle 10 as determined from the driver's operation without exceeding the torque upper limit value Tmax. This slow change process performed on the changes of the request torque Tm prevents rapid changes of the vehicle speed V.

In this embodiment, the slow change process is performed only on the changes of the request torque Tm, not on the changes of the torque upper limit value Tmax. Alternatively, the slow change process may also be performed on the changes of the torque upper limit value Tmax as in the following.

To control (increase/decrease) the torque upper limit value Tmax from the current upper limit value (e.g., TmaxA) to a upper limit value TmaxB, the control section 33B obtains an upper limit value deviation ΔTmax by subtracting a upper limit value TmaxA from the upper limit value TmaxB and determines whether or not the upper limit value deviation ΔTmax is lower than or equal to a first threshold ΔTmax1 (>0) and higher than or equal to a second threshold ΔTmax2 (<0). If it is determined that the upper limit value deviation ΔTmax is in that range, the control section 33B controls (increases/decreases) the torque upper limit value Tmax from the current upper limit value TmaxA to the upper limit value TmaxB.

On the other hand, if it is determined that the upper limit value deviation ΔTmax is higher than the first threshold ΔTmax1, the control section 33B, as the slow change process, controls (increases) the torque upper limit value Tmax to a value obtained by adding the first threshold ΔTmax1 to the upper limit value TmaxA, instead of controlling (increasing) the torque upper limit value Tmax to the upper limit value TmaxB. Meanwhile, if it is determined that the upper limit value deviation ΔTmax is lower than the second threshold ΔTmax2, the control section 33B, as the slow change process, controls (decreases) the torque upper limit value Tmax to a value obtained by adding the second threshold ΔTmax2 to the upper limit value TmaxA, instead of controlling (decreasing) the torque upper limit value Tmax to the upper limit value TmaxB. This process is repeated until the torque upper limit value Tmax reaches the upper limit value TmaxB. In this manner, the torque upper limit value Tmax is controlled (increased/decreased) slowly from the current upper limit value TmaxA to the upper limit value TmaxB. This slow change process performed on the changes of the torque upper limit value Tmax prevents rapid decreases of the torque upper limit value Tmax. That prevents rapid decreases of the request torque Tm that would otherwise be caused by the rapid decreases of the torque upper limit value Tmax, which in turn prevents rapid changes of the vehicle speed V.

In this embodiment, the slow change process may be performed only on the changes of the torque upper limit value Tmax, and not on the changes of the request torque Tm. Alternatively, the slow change process performed on the changes of the torque upper limit value Tmax may be simplified by gradually increasing or decreasing the torque upper limit value Tmax at all times, without using the thresholds ΔTmax1 and ΔTmax2. In addition, the slow change process may be performed neither on the changes of the torque upper limit value Tmax nor on the changes of the request torque Tm.

In this embodiment, the torque upper limit value Tmax is changed (increased/decreased) to a first upper limit value Tmax1 for normal travel, a second upper limit value Tmax2 for battery saving mode that is lower than the first upper limit value Tmax1, or a third upper limit value Tmax3 for restricting vehicle speed V preparing for the traction battery B being died that is lower than the second upper limit value Tmax2.

The first upper limit value Tmax1 is specified to such a high value that the torque upper limit value Tmax would practically not limit the vehicle speed V.

The second upper limit value Tmax2 is an upper limit value by which the vehicle 10 is restricted to travel at a speed lower than or equal to a predetermined vehicle speed V1 (battery saving mode) to prevent the traction battery B from being died (in other words, to reduce decreases of the remaining SOC of the traction battery B).

The third upper limit value Tout3 is an upper limit value by which the vehicle 10 is restricted to travel at a speed lower than or equal to a predetermined vehicle speed V2 (<V1) (low vehicle speed state). The vehicle speed V2 is a predetermined vehicle speed (SMR-openable vehicle speed) at which the back electromotive force induced in the electric motor M when the relays SMR1 and SMR2 are opened is restrained to such a level that the electrical devices (e.g., auxiliary equipment 27) connected to the power supply lines 101 and 102 are prevented from being damaged by the back electromotive force.

The control section 33B controls the request torque Tm for the electric motor M according to results of judgments made by the traction battery power management section 32 to restrict the vehicle speed V of the vehicle 10.

To describe it in more detail, if the traction battery power management section 32 determines that the remaining SOC of the traction battery B is not lower than or equal to a first remaining SOC1, the control section 33B determines that there is no request for battery saving mode for the vehicle 10 and controls the torque upper limit value Tmax to be equal to the first upper limit value Tmax1.

In this manner, the control section 33B controls the electric motor M via the inverter 21 without allowing torque to exceed the first upper limit value Tmax1. That enables normal travel of the vehicle 10 (in other words, since the upper limit value Tmax1 is sufficiently high, the upper limit value Tmax1 does not limit the vehicle speed V, allowing the vehicle 10 to travel at a vehicle speed V as determined from the driver's operation).

On the other hand, if the traction battery power management section 32 determines that the remaining SOC of the traction battery B is lower than or equal to the first remaining SOC1, the control section 33B determines that there is a request for battery saving mode for the vehicle 10 and controls the torque upper limit value Tmax to be equal to the second upper limit value Tmax2. In this manner, the control section 33B controls the electric motor M via the inverter 21 without allowing torque to exceed the second upper limit value Tmax2. That restricts the vehicle speed V to or below the vehicle speed V1, which in turn enables battery saving mode of the vehicle 10.

If the traction battery power management section 32 determines that the remaining SOC of the traction battery B is lower than or equal to the second remaining SOC2, the control section 33B determines that there is a request for restricting vehicle speed V preparing for the traction battery B being died of the vehicle speed V (i.e., restriction of the vehicle speed V to a value that is lower than or equal to the SMR-openable vehicle speed V2) and controls the torque upper limit value Tmax to be equal to the third upper limit value Tmax3. In this manner, the control section 33B controls the electric motor M via the inverter 21 without allowing torque to exceed the third upper limit value Tmax3. That restricts the vehicle 10 to travel in the low vehicle speed state (at a speed below or equal to the SMR-openable vehicle speed V2).

If the traction battery power management section 32 determines that the remaining SOC of the traction battery B is lower than or equal to the third remaining charge, the control section 33B determines that there is a request that the relays SMR1 and SMR2 be opened and controls the relays SMR1 and SMR2 to turn off. On the other hand, if the traction battery power management section 32 determines that the remaining SOC of the traction battery B is not lower than or equal to the third remaining charge, the control section 33B determines that there is no request that the relays SMR1 and SMR2 be opened and controls the relays SMR1 and SMR2 to turn on. This turn-off control prevents the traction battery B from being overdischarged in the died state.

When the vehicle 10 is in braking by the electric motor M, the control section 33B controls the inverter 21 to convert the three-phase AC electric power generated by the electric motor M to DC electric power to charge the traction battery B. The control section 33B also controls the DC/DC converter 29 to convert the DC electric power supplied by the traction battery B to a voltage suited to the auxiliary equipment 27 for supply to the auxiliary equipment 27.

The vehicle speed control device 1B in accordance with this embodiment includes at least the inverter 21, the control device 31, the electric motor M, the relays SMR1 and SMR2, the traction battery B, and the vehicle sensors S1 to S5.

### —Operation—

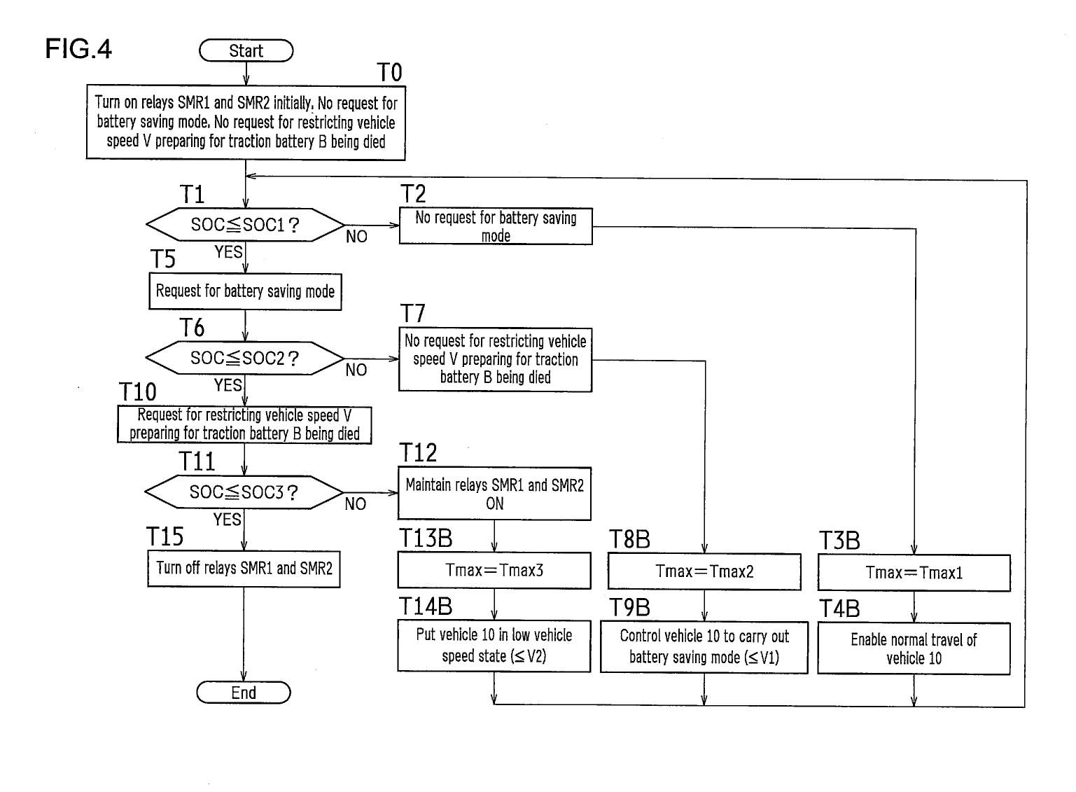

An operation of the vehicle speed control device 1B will be described in reference to FIG. 4. FIG. 4 is a flow chart depicting an operation of the vehicle speed control device 1B.

Steps T0 to T2, T5 to T7, T10 to T12, and T15 in FIG. 4 are the same as steps T0 to T2, T5 to T7, T10 to T12, and T15 in FIG. 2 respectively, and their description will be omitted. The following description will focus on steps T3B, T4B, T8B, T9B, T13B, and T14B that differ from steps in FIG. 2.

In this embodiment, the operation proceeds from step T2 to step T3B where the control section 33B controls the torque upper limit value Tmax for the electric motor M to be equal to the first upper limit value Tmax1. The control section 33B, in step T4B, controls the electric motor M via the inverter 21 without allowing torque to exceed the torque upper limit value Tmax (=Tmax1). That enables normal travel of the vehicle 10 (in other words, the vehicle can travel practically with no speed limit). The operation then returns to step T1.

In this embodiment, the operation proceeds from step T7 to step T8B where the control section 33B controls the torque upper limit value Tmax for the electric motor M to be equal to the second upper limit value Tmax2. The control section 33B, in step T9B, controls the electric motor M via the inverter 21 without allowing torque to exceed the torque upper limit value Tmax (=Tmax2). That restricts the vehicle 10 to battery saving mode (in other words, the vehicle 10 is restricted to travel at the vehicle speed V1 or at a lower speed). The operation then returns to step T1.

In this embodiment, the operation proceeds from step T12 to step T13B where the control section 33B controls the torque upper limit value Tmax for the electric motor M to be equal to the third upper limit value Tmax3. The control section 33B, in step T14B, controls the electric motor M via the inverter 21 without allowing torque to exceed the torque upper limit value Tmax (=Tmax3). That restricts the vehicle 10 to low vehicle speed travel (at a speed that is lower than or equal to the SMR-openable vehicle speed V2). The operation then returns to step T1.

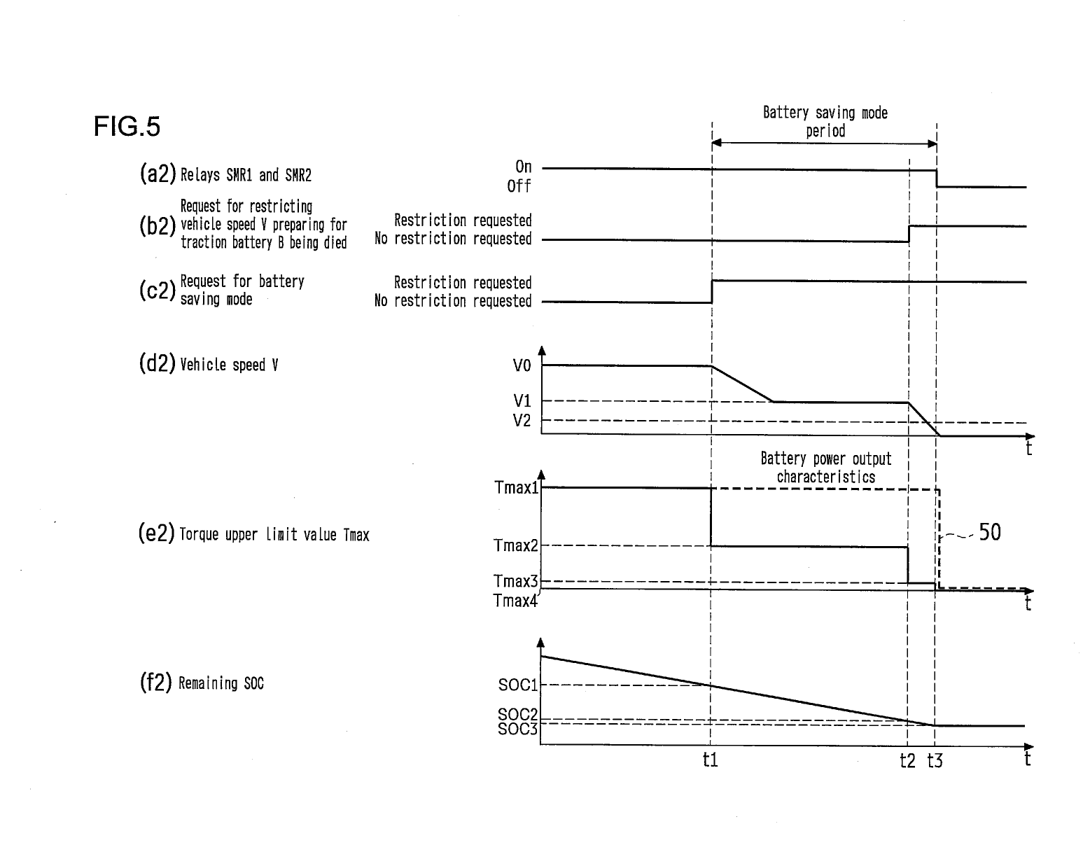

Next, the operation shown in FIG. 4 will be described as it is applied to the case shown in FIG. 5.

FIG. 5 is a time chart depicting temporal variations (f2) of the remaining SOC of the traction battery B and also depicting, for this exemplary case, ON/OFF timings (a2) for the relays SMR1 and SMR2, a timing (b2) for a request for restricting vehicle speed V preparing for the traction battery B being died, a timing (c2) for a request for battery saving mode, temporal variations (d2) of the vehicle speed V, and increase/decrease timings (e2) for the torque upper limit value Tmax.

In FIG. 5, as the vehicle 10 travels, the remaining SOC decreases to the first remaining SOC1 (i.e., low remaining charge state) at time t1, to the second remaining SOC2 (i.e., battery just before died state) at time t2, and to the third remaining SOC3 (i.e., died state) at time t3. The operation shown in

FIG. 4 is applied to this exemplary case as follows.

During time t<t1, the remaining SOC of the traction battery B decreases within the limit, SOC1<SOC, and steps T0, T1, T2, T3B, T4B, and T1 in FIG. 4 are therefore repeated in this order. The control section 33B thus controls the relays SMR1 and SMR2 to turn on (step T0), determines that there is neither a request for battery saving mode nor a request for restricting vehicle speed V preparing for the traction battery B being died (steps T0 and T2), and controls the torque upper limit value Tmax to be equal to the first upper limit value Tmax1 (step T3B). The vehicle 10 hence carries out normal travel as determined from the driver's operation (step T4B). FIG. 5 shows that the vehicle 10 is traveling, for example, at a vehicle speed V0 (normal travel) as determined from the driver's operation.

At time t=t1, the remaining SOC of the traction battery B reaches the first remaining SOC1, and the operation flow changes: steps T1, T5, T6, T7, T8B, T9B, and T1 in FIG. 4 are carried out in this order. The control section 33B thus determines that there is a request for battery saving mode (step T5), controls the torque upper limit value Tmax to be equal to the second upper limit value Tmax2 (step T8B), and controls the vehicle 10 to carry out battery saving mode at the vehicle speed V1 or at a lower speed (step T9B). During t1<t<t2, steps T1, T5, T6, T7, T8B, T9B, and T1 in FIG. 4 are repeated in this order. In FIG. 5, a slow change process is carried out to slowly control the vehicle speed V to be equal to or below the vehicle speed V1 when the target torque Tm* is specified. FIG. 5 shows that at t1<t<t2, the vehicle 10 travels at the vehicle speed V1 as an example.

At time t=t2, the remaining SOC of the traction battery B reaches the second remaining SOC2, and the operation flow changes: steps T1, T5, T6, T10, T11, T12, T13B, T14B, and T1 in FIG. 4 are carried out in this order. The control section 33B thus determines that there is a request for restricting vehicle speed V preparing for the traction battery B being died (step T10), controls the torque upper limit value Tmax to be equal to the third upper limit value Tmax3 (step T13B), and controls the vehicle 10 to travel in the low vehicle speed state at the SMR-openable vehicle speed V2 or at a lower speed (step T14B). During t2<t<t3, steps T1, T5, T6, T10, T11, T12, T13B, T14B, and T1 in FIG. 4 are repeated in this order. In FIG. 5, a slow change process is carried out on the changes of the request torque Tm. The vehicle speed V is therefore slowly controlled to be lower than or equal to the vehicle speed V2.

At time t=t3, the remaining SOC of the traction battery B reaches the third remaining SOC3, and the operation flow changes: steps T1, T5, T6, T10, T11, and T15 in FIG. 4 are carried out in this order. The control section 33B thus determines that the traction battery B is in the died state, thereby opening the relays SMR1 and SMR2 (controls the relays SMR1 and SMR2 to turn off) (step T15) and controlling the torque upper limit value Tmax to be equal to, for example, a torque stopping level Tmax4 (<Tmax3). When the relays SMR1 and SMR2 are opened, the vehicle 10 is already in the low vehicle speed state (traveling at the SMR-openable vehicle speed V2 or at a lower speed) (in other words, the electric motor M is controlled so that the vehicle speed V travels at a low vehicle speed that is below or equal to the SMR-openable vehicle speed V2). Therefore, the back electromotive force that occurs in the electric motor M when the relays SMR1 and SMR2 are opened is reduced. That prevents electrical devices (e.g., auxiliary equipment 27) connected to the lines 101 and 102 from being damaged by the back electromotive force that occurs in the electric motor M when the relays SMR1 and SMR2 are opened.

### —Major Effects—

According to the vehicle speed control device 1B configured as above, the same effects as in the first embodiment are achieved by the common part. In addition to that, by reducing the torque upper limit value Tmax, the electric motor M is controlled so that the vehicle speed V is restricted to or below the predetermined vehicle speed V2. Therefore, the electric motor M is controlled so that the vehicle speed V when the traction battery B is died can be restricted to or below the predetermined vehicle speed V2 by simply changing the setting of the torque upper limit value Tmax (in other words, through a simple process). This control, similarly to the first embodiment, reduces the back electromotive force induced in the electric motor by the relays SMR1 and SMR2 being opened (being controlled to turn off) when the traction battery B is died and prevents the predetermined electrical devices (e.g., auxiliary equipment 27) connected to the lines (electrical paths) 101 and 102 from being damaged by the back electromotive force induced in the electric motor.

The slow change process is performed in reducing the torque upper limit value Tmax or in reducing the vehicle speed V after the reduction of the torque upper limit value Tmax, to slowly change the reduction of the torque upper limit value Tmax or the vehicle speed V. That prevents the vehicle speed V from rapidly changing and prevents poor drivability (maneuverability, ride quality). In this embodiment, the slow change process is performed on the reduction of the vehicle speed V by performing the slow change process on the changes of the request torque Tm.

### Third Embodiment

In the second embodiment, the vehicle speed V of the vehicle is restricted directly by controlling the request torque Tm of the electric motor M in response to a request for battery saving mode or a request for restricting vehicle speed V preparing for the traction battery B being died. Meanwhile, in this embodiment, the vehicle speed V of the vehicle 10 is restricted directly by controlling a braking system in the vehicle in response to a request for battery saving mode or a request for restricting vehicle speed V preparing for the traction battery B being died. In the following, the same claim elements as in the second embodiment will be given the same reference numerals, and their description will be omitted. The description will focus on differences from the second embodiment.

### —Structure—

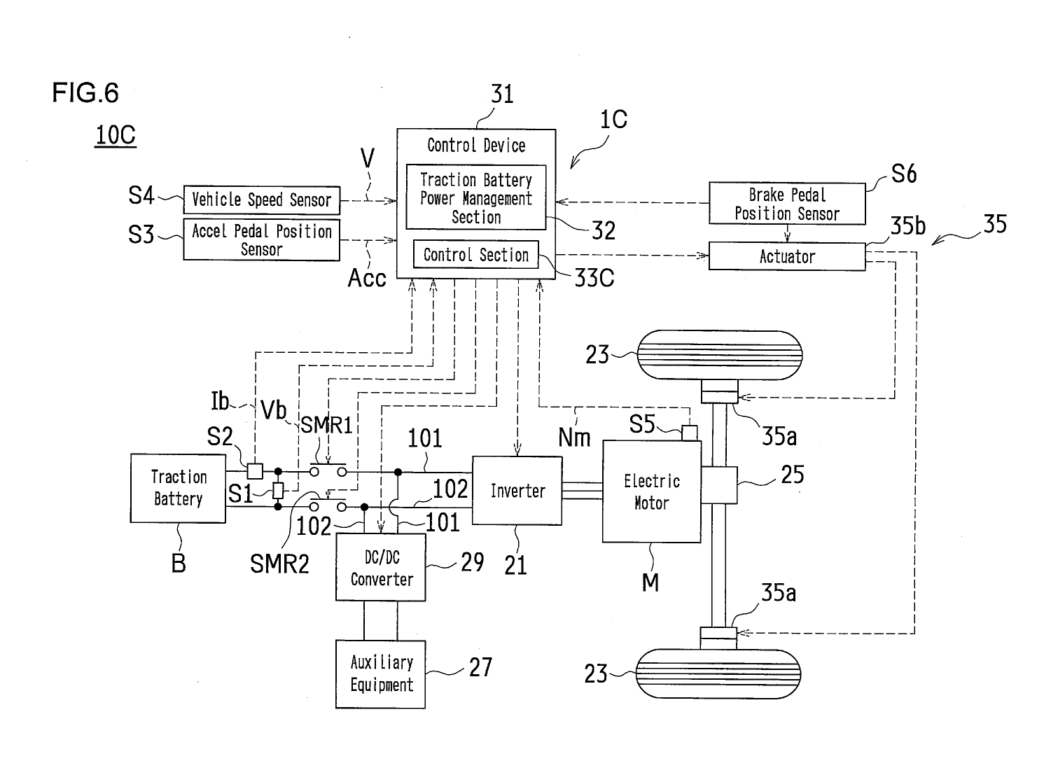

FIG. 6 is a structural schematic view of a vehicle including a vehicle speed control device in accordance with the third embodiment.

As illustrated in FIG. 6, the vehicle 10C in accordance with this embodiment includes, on top of the vehicle 10 of the second embodiment, a braking system 35 for braking the vehicle 10C. The braking system 35 brakes the drive wheels (wheels) 23 in this embodiment. Alternatively, if the vehicle 10C includes non-driven wheels (wheels), the braking system 35 may brake the non-driven wheels either in place of the drive wheels 23 or in addition to the drive wheels 23.

The braking system 35 includes: a braking device (e.g., a brake wheel cylinder) 35a that applies braking force to, for example, the drive wheels 23; a brake pedal position sensor S6 that detects the depression level of the brake pedal; and an actuator (e.g., a brake actuator) 35b that drives the braking device 35a according to a detected value supplied from the brake pedal position sensor S6 (in other words, the brake pedal position BP).

The actuator 35b controls braking of the vehicle 10C according to the depression level of the brake pedal by controlling braking force applied to the drive wheels 23 by the braking device 35a according to a detected value supplied from the brake pedal position sensor S6. The actuator 35b controls braking of the vehicle 10C by controlling braking force applied to the drive wheels 23 by the braking device 35a under the control of a control section 33C (detailed later). The braking system 35 co-operate controls with the electric motor M by controlling braking of the vehicle 10C. Thus, the braking system 35 controls the regeneration power of the electric motor M.

The vehicle speed control device 1C in accordance with this embodiment includes the control section 33C (detailed below) replacing the control section 33B in the vehicle speed control device 1B in accordance with the second embodiment.

The control section 33C in accordance with this embodiment controls the vehicle speed V of the vehicle 10C to a vehicle speed as determined from the driver's operation by controlling the electric motor M via the inverter 21 based on the detected values supplied from, for example, the sensors S3, S4, and S6 (accel pedal opening angle Acc, vehicle speed V, brake pedal position BP, etc.).

The control section 33C also restricts the vehicle speed V of the vehicle 10C by controlling the braking system 35 (in other words, by controlling the braking device 35a via the actuator 35b) according to results of judgments made by the traction battery power management section 32 and the detected value V supplied from the vehicle speed sensor S4. The inverter 21 may be controlled by the control section 33C so that the electric motor M can operate in regenerative mode during the restriction.

To describe it in more detail, if the traction battery power management section 32 determines that the remaining SOC of the traction battery B is not lower than or equal to the first remaining SOC1, the control section 33C determines that there is no request for battery saving mode for the vehicle 10C and refrains from controlling the braking system 35 (in other words, the control section 33C does not restrict the vehicle speed V via the braking system 35). That enables normal travel of the vehicle 10C (in other words, the vehicle speed V is not restricted by the braking system 35 under the control of the control section 33C, and the vehicle 10C can travel at a vehicle speed V as determined from the driver's operation).

On the other hand, if the traction battery power management section 32 determines that the remaining SOC of the traction battery B is lower than or equal to the first remaining SOC1, the control section 33C determines that there is a request for battery saving mode for the vehicle 10C. If the control section 33C determines in this manner that there is a request for battery saving mode, the control section 33C determines whether or not the vehicle speed V is lower than or equal to a vehicle speed V1. The vehicle speed V1 is a predetermined vehicle speed by which decreases of the remaining SOC of the traction battery B are restrained.

If it is determined that the vehicle speed V is lower than or equal to the vehicle speed V1, the control section 33C refrains from controlling the braking system 35 (in other words, the control section 33C does not restrict the vehicle speed V via the braking system 35). On the other hand, if it is determined that the vehicle speed V is not lower than or equal to the vehicle speed V1, the control section 33C controls the braking system 35 so that the vehicle speed V drops to the vehicle speed V1 (in other words, so that the vehicle speed V does not exceed the vehicle speed V1) (hence, the electric motor M is controlled by the braking system 35 so that the vehicle speed V drops to the vehicle speed V1). In this manner, the vehicle 10C is controlled to carry out battery saving mode at the vehicle speed V1 or at a lower speed.

In addition, if the traction battery power management section 32 determines that the remaining SOC of the traction battery B is lower than or equal to the second remaining SOC2, the control section 33C determines that there is a request for restricting vehicle speed V preparing for the traction battery B being died of the vehicle speed V of the vehicle 10C. If the control section 33C determines in this manner that there is a request for restricting vehicle speed V preparing for the traction battery B being died, the control section 33C determines whether or not the vehicle speed V is lower than or equal to a vehicle speed V2. The vehicle speed V2 is a predetermined vehicle speed (SMR-openable vehicle speed) at which the back electromotive force induced in the electric motor M when the relays SMR1 and SMR2 are opened is restrained to such a level that the electrical devices (e.g., auxiliary equipment 27) connected to the lines 101 and 102 are prevented from being damaged by the back electromotive force.

If it is determined that the vehicle speed V is lower than or equal to the vehicle speed V2, the control section 33C refrains from controlling the braking system 35. On the other hand, if it is determined that the vehicle speed V is not lower than or equal to the vehicle speed V2, the control section 33C controls the braking system 35 so that the vehicle speed V drops to the vehicle speed V2 (in other words, so that the vehicle speed V does not exceed the vehicle speed V2) (hence, the electric motor M is controlled by the braking system 35 so that the vehicle speed V drops to the vehicle speed V2). In this manner, the vehicle 10C is controlled to travel in the low vehicle speed state at the SMR-openable vehicle speed V2 or at a lower speed.

In addition, if the traction battery power management section 32 determines that the remaining SOC of the traction battery B is lower than or equal to the third remaining charge, the control section 33C determines that there is a request that the relays SMR1 and SMR2 be opened and controls the relays SMR1 and SMR2 to turn off. On the other hand, if the traction battery power management section 32 determines that the remaining SOC of the traction battery B is not lower than or equal to the third remaining charge, the control section 33C determines that there is no request that the relays SMR1 and SMR2 be opened and controls the relays SMR1 and SMR2 to turn on. This turn-off control prevents the traction battery B from being overdischarged in the died state.

When the vehicle 10C is in braking by the electric motor M, the control section 33C controls the inverter 21 to convert the three-phase AC electric power generated by the electric motor M to DC electric power to charge the traction battery B. The control section 33C also controls the DC/DC converter 29 to convert the DC electric power supplied by the traction battery B to a voltage suited to the auxiliary equipment 27 for supply to the auxiliary equipment 27.

The vehicle speed control device 1C in accordance with this embodiment includes at least the inverter 21, the control device 31, the electric motor M, the relays SMR1 and SMR2, the traction battery B, the vehicle sensors S1 to S5, and the braking system 35.

### —Operation—

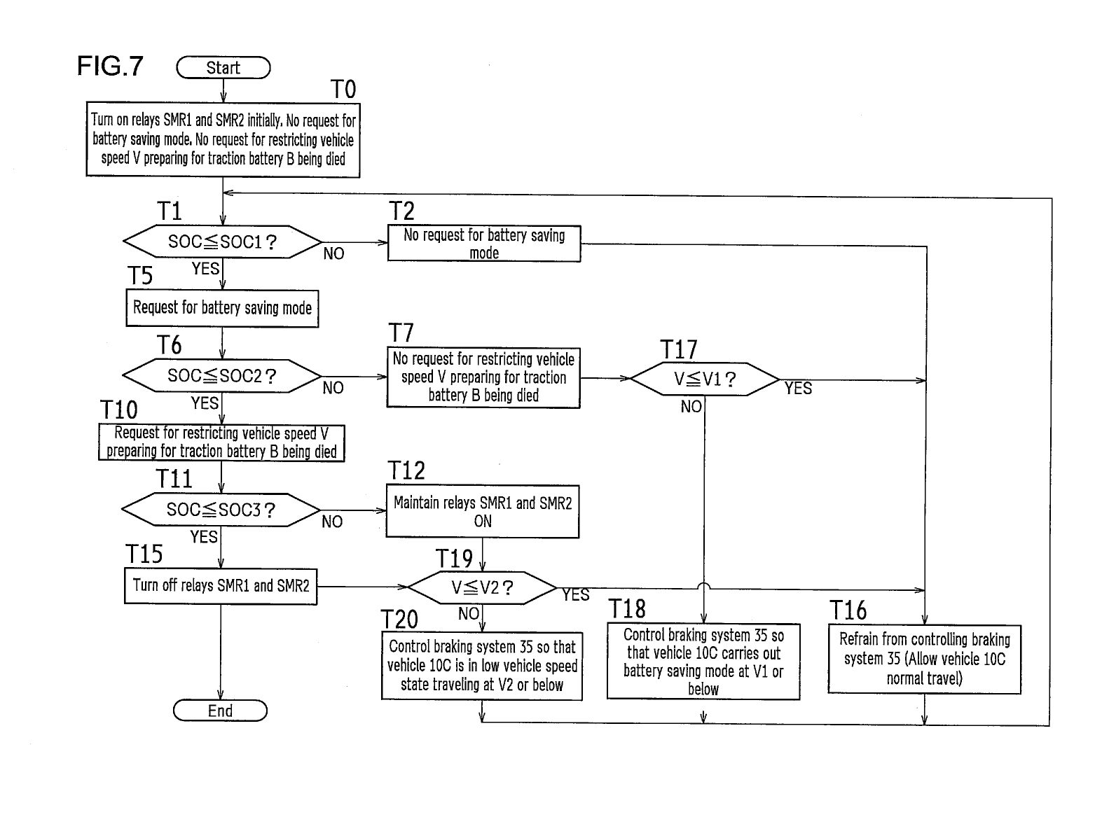

An operation of the vehicle speed control device 1C will be described in reference to FIG. 7. FIG. 7 is a flow chart depicting an operation of the vehicle speed control device 1C.

Steps T0 to T2, T5 to T7, T10 to T12, and T15 in FIG. 4 are the same as steps T0 to T2, T5 to T7, T10 to T12, and T15 in FIG. 4 respectively, and their description will be omitted. The following description will focus on steps T16 to T20 that differ from steps in FIG. 4.

In this embodiment, the operation proceeds from step T2 to step T16 where the control section 33C refrains from controlling the braking system 35. That enables normal travel of the vehicle 10. The operation then returns to step T1.

In this embodiment, the operation proceeds from step T7 to step T17 where the control section 33C determines whether or not the vehicle speed V is lower than or equal to the vehicle speed V1. If it is determined that the vehicle speed V is lower than or equal to the vehicle speed V1, the operation proceeds to step T16. On the other hand, if it is determined that the vehicle speed V is not lower than or equal to the vehicle speed V1, the operation proceeds to step T18 where the control section 33C controls the braking system 35 so that the vehicle speed V drops to the vehicle speed V1. In this manner, the vehicle 10C is controlled to carry out battery saving mode at the vehicle speed V1 or at a lower speed. The operation then returns to step T1.

In this embodiment, the operation proceeds from step T12 to step T19 where the control section 33C determines whether or not the vehicle speed V is lower than or equal to the vehicle speed V2. If it is determined that the vehicle speed V is lower than or equal to the vehicle speed V2, the operation proceeds to step T16. On the other hand, if it is determined that the vehicle speed V is not lower than or equal to the vehicle speed V2 (SMR-openable vehicle speed), the operation proceeds to step T20 where the control section 33C controls the braking system 35 so that the vehicle 10C decelerates to the vehicle speed V2. In this manner, the vehicle 10C is controlled so that the vehicle 10C is in the low vehicle speed state that is below or equal to the vehicle speed V2. The operation then returns to step T1.

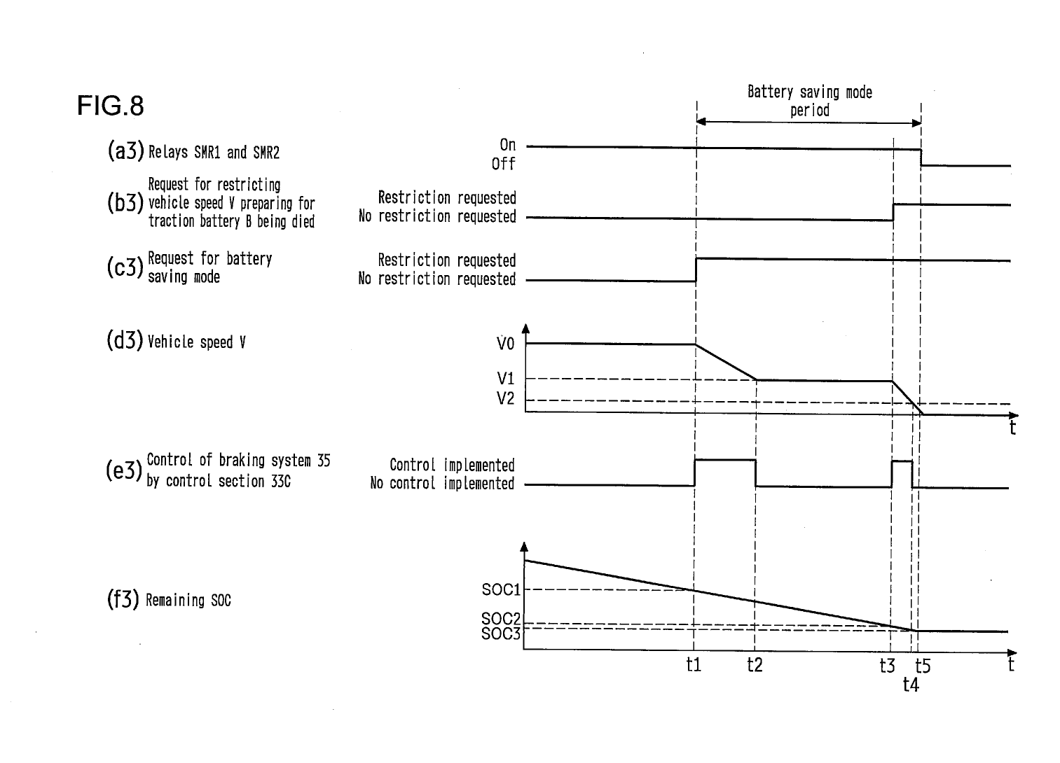

Next, the operation shown in FIG. 7 will be described as it is applied to the case shown in FIG. 8.

FIG. 8 is a time chart depicting temporal variations (f3) of the remaining SOC of the traction battery B and also depicting, for this exemplary case, ON/OFF timings (a3) for the relays SMR1 and SMR2, a timing (b3) for a request for restricting vehicle speed V preparing for the traction battery B being died, a timing (c3) for a request for battery saving mode, temporal variations (d3) of the vehicle speed V, and a timing (e3) for the control section 33C to control the braking system 35.

In FIG. 8, as the vehicle 10C travels, the remaining SOC decreases to the first remaining SOC1 (i.e., low remaining charge state) at time t1, to the second remaining SOC2 (i.e., battery just before died state) at time t3, and to the third remaining SOC3 (i.e., died state) at time t5. The operation shown in FIG. 7 is applied to this exemplary case as follows.

During time t<t1, the remaining SOC of the traction battery B decreases within the limit, SOC1<SOC, and steps T0, T1, T2, T16, and T1 in FIG. 7 are therefore repeated in this order. The control section 33C thus controls the relays SMR1 and SMR2 to turn on (step T0), determines that there is neither a request for battery saving mode nor a request for restricting vehicle speed V preparing for the traction battery B being died (steps T0 and T2), and refrains from controlling the braking system 35 (step T16). The vehicle 10C hence carries out normal travel as determined from the driver's operation. FIG. 5 shows that the vehicle 10 is traveling, for example, at a vehicle speed V0 (>V1, normal travel) as determined from the driver's operation.

At time t=t1, the remaining SOC of the traction battery B reaches the first remaining SOC1 when the vehicle speed V is equal to the vehicle speed V0 (>V1), and the operation flow changes: steps T1, T5, T6, T7, T17, T18, and T1 in FIG. 7 are carried out. The control section 33C thus determines that there is a request for battery saving mode (step T5), determines that the vehicle speed V is not lower than or equal to the vehicle speed V1 (NO in step T17), and controls the braking system 35 to brake the vehicle 10C (step T18). In this manner, the vehicle speed V of the vehicle 10C is reduced to the vehicle speed V1. During t1<t<t2, steps T1, T5, T6, T7, T17, T18, and T1 in FIG. 7 are repeated in this order.

At time t=t2, the vehicle speed V reaches the vehicle speed V1, and the operation flow changes: steps T1, T5, T6, T7, T17, T16, and T1 in FIG. 7 are carried out. The control section 33C thus no longer controls the braking system 35, enabling normal travel of the vehicle 10C. In this embodiment, after the control section 33C stops controlling the braking system 35, the vehicle 10C carries out normal travel, for example, at the vehicle speed V1 as determined from the driver's operation. During t2<t<t3, steps T1, T5, T6, T7, T17, T16, and T1 in FIG. 7 are repeated in this order. FIG. 8 shows that during t2<t<t3, the vehicle 10C is driven by the driver to carry out normal travel at the vehicle speed V1.

At time t=t3, the remaining SOC of the traction battery B reaches the second remaining SOC2 when the vehicle speed V is equal to the vehicle speed V1 (>V2), and the operation flow changes: steps T1, T5, T6, T10, T11, T12, T19, T20, and T1 in FIG. 7 are carried out. The control section 33C thus determines that there is a request for restricting vehicle speed V preparing for the traction battery B being died (step T10), determines that the vehicle speed V is not lower than or equal to the vehicle speed V2 (NO in step T19), and controls the braking system 35 to brake the vehicle 10C (step T20). In this manner, the vehicle speed V of the vehicle 10C is reduced to the vehicle speed V2 (in other words, the electric motor M is controlled by the braking system 35 so that the vehicle speed V drops to the vehicle speed V2). During t3<t<t4, steps T1, T5, T6, T10, T11, T12, T19, T20, and T1 in FIG. 7 are repeated in this order.

At time t=t4, the vehicle speed V reaches the vehicle speed V2, and the operation flow changes: steps T1, T5, T6, T10, T11, T12, T19, T16, and T1 in FIG. 7 are carried out. The control section 33C thus no longer controls the braking system 35, enabling normal travel of the vehicle 10C. In this embodiment, after the control section 33C stops controlling the braking system 35, the vehicle 10C carries out normal travel at the vehicle speed V2 or at a lower speed. During t4<t<t5, steps T1, T5, T6, T10, T11, T12, T19, T16, and T1 in FIG. 7 are repeated in this order. In this embodiment, FIG. 8 shows that during t4<t<t5, the vehicle 10C is driven by the driver to carry out normal travel at the vehicle speed V2 or at a lower speed.

At time t=t5, the remaining SOC of the traction battery B reaches the third remaining SOC3, and the operation flow changes: steps T1, T5, T6, T10, T11, and T15 in FIG. 7 are carried out in this order. The control section 33C thus determines that the traction battery B is in the died state and opens the relays SMR1 and SMR2 (controls the relays SMR1 and SMR2 to turn off) (step T15). When the relays SMR1 and SMR2 are opened, the vehicle 10C is already in the low vehicle speed state at the SMR-openable vehicle speed V2 or at a lower speed (in other words, the electric motor M is being controlled so that the vehicle speed V is equal to a low vehicle speed that is below or equal to the SMR-openable vehicle speed V2). Therefore, the back electromotive force that occurs in the electric motor M when the relays SMR1 and SMR2 are opened is reduced. That prevents the electrical devices (e.g., auxiliary equipment 27) connected to lines 101 and 102 from being damaged when the relays SMR1 and SMR2 are opened.

### —Major Effects—

According to the vehicle speed control device 1C configured as above, the same effects as in the first and second embodiments are achieved by the common part. In addition to that, by braking the vehicle 10C with the braking system 35, the electric motor M is controlled so that the vehicle speed V is restricted to or below the predetermined vehicle speed V2. Therefore, the electric motor M is controlled so that the vehicle speed V when the traction battery B is died can be restricted to or below the predetermined vehicle speed V2 using the braking system 35 installed in the vehicle V as a standard component (in other words, without installing an additional device). This control, similarly to the first and second embodiments, reduces the back electromotive force induced in the electric motor by the relays SMR1 and SMR2 being opened (being controlled to turn off) when the traction battery B is died and prevents the predetermined electrical devices (e.g., auxiliary equipment 27) connected to the lines (electrical paths) 101 and 102 from being damaged by the back electromotive force induced in the electric motor.

### (Additional Description)

Preferred embodiments of the present invention have been described so far in reference to attached drawings. The present invention is by no means limited to these examples, but may be altered or modified by a skilled person within the scope of the claims, without departing from the technical scope of the present invention.

In addition, any combination of the first to third embodiments is encompassed in the technical scope of the present invention.

### INDUSTRIAL APPLICABILITY

The present invention is suited to applications to vehicle speed control devices that control the vehicle speed of a vehicle, such as an electric vehicle including as a driving force source an electric motor that is driven by electric power from a traction battery.

### REFERENCE SIGNS LIST

1, 1B, 1C Vehicle speed control device
10,10C Vehicle
21 Inverter (Drive circuit)
23 Drive wheel (Wheel)
35 Braking system
101 Power supply line (Electrical path)
102 Ground line (Electrical path)
M Electric motor
B Traction battery
SOC1 First remaining charge (Predetermined low remaining charge state)
SOC2 Second remaining charge (Battery just before died state)
SOC3 Third remaining charge (Died state)
V1 Predetermined vehicle speed (Second predetermined vehicle speed)
V2 Predetermined vehicle speed (SMR-openable vehicle speed, First predetermined vehicle speed)
Wout Electric power supply upper limit value setting
Tmax Torque upper limit value

1. A vehicle speed control device, comprising:
a traction battery;
an electric motor that drives wheels of a vehicle to rotate;
a drive circuit, connected to the traction battery via electrical paths, that converts DC electric power supplied by the traction battery to AC electric power for supply to the electric motor; and
relays provided on the electrical paths,
wherein the vehicle speed control device, which performs a first judgment as to whether or not the traction battery is in a died state and which, if it is determined in the first judgment that the traction battery is in the died state, turns off the relays, performs a second judgment as to whether or not the traction battery is in a battery just before died state, and if it is determined in the second judgment that the traction battery is in the battery just before died state, controls the electric motor to restrict vehicle speed to a first predetermined vehicle speed or to a lower vehicle speed.

2. The vehicle speed control device as set forth in claim 1, wherein:
the drive circuit has an electric power supply upper limit value setting as to an electric power that the drive circuit is capable of supplying to the electric motor; and
the vehicle speed control device, if it is determined in the second judgment that the traction battery is in the battery just before died state, controls the electric motor to restrict vehicle speed to the first predetermined vehicle speed or to a lower speed by reducing the usable electric power supply upper limit value setting.

3. The vehicle speed control device as set forth in claim 1, wherein:
the electric motor has a torque upper limit value setting; and
the vehicle speed control device, if it is determined in the second judgment that the traction battery is in the battery just before died state, controls the electric motor to restrict vehicle speed to the first predetermined vehicle speed or to a lower speed by reducing the usable torque upper limit value setting.

4. The vehicle speed control device as set forth in claim 1, further comprising a braking system that brakes the vehicle, wherein
the vehicle speed control device, if it is determined in the second judgment that the traction battery is in the battery just before died state, controls the electric motor to restrict vehicle speed to the first predetermined vehicle speed or to a lower speed by the braking the vehicle.

5. The vehicle speed control device as set forth in claim 1, wherein:
the drive circuit has an electric power supply upper limit value setting as to an electric power that the drive circuit is capable of supplying to the electric motor; and
the vehicle speed control device performs a third judgment as to whether or not the traction battery is in a predetermined low remaining charge state in which the traction battery has more remaining charge than in the battery just before died state, and if it is determined in the third judgment that the traction battery is in the predetermined low remaining charge state, controls the electric motor to restrict vehicle speed to a second predetermined vehicle speed or to a lower speed by reducing the electric power supply upper limit value setting, the second predetermined vehicle speed being higher than the first predetermined vehicle speed.

6. The vehicle speed control device as set forth in claim 2, wherein the vehicle speed control device performs a slow change process that slows down lowering of the usable electric power supply upper limit value setting or slows down lowering of the vehicle speed caused by the lowering of the electric power supply upper limit value setting.

7. The vehicle speed control device as set forth in claim 3, wherein the vehicle speed control device performs a slow change process that slows down lowering of the torque upper limit value setting or slows down lowering of the vehicle speed caused by the lowering of the usable torque upper limit value setting.

8. A vehicle, comprising a vehicle speed control device as set forth in claim 1.

9. The vehicle speed control device as set forth in claim 2, wherein:
the drive circuit has an electric power supply upper limit value setting as to an electric power that the drive circuit is capable of supplying to the electric motor; and
the vehicle speed control device performs a third judgment as to whether or not the traction battery is in a predetermined low remaining charge state in which the traction battery has more remaining charge than in the battery just before died state, and if it is determined in the third judgment that the traction battery is in the predetermined low remaining charge state, controls the electric motor to restrict vehicle speed to a second predetermined vehicle speed or to a lower speed by reducing the electric power supply upper limit value setting, the second predetermined vehicle speed being higher than the first predetermined vehicle speed.

10. The vehicle speed control device as set forth in claim 3, wherein:
the drive circuit has an electric power supply upper limit value setting as to an electric power that the drive circuit is capable of supplying to the electric motor; and
the vehicle speed control device performs a third judgment as to whether or not the traction battery is in a predetermined low remaining charge state in which the traction battery has more remaining charge than in the battery just before died state, and if it is determined in the third judgment that the traction battery is in the predetermined low remaining charge state, controls the electric motor to restrict vehicle speed to a second predetermined vehicle speed or to a lower speed by reducing the electric power supply upper limit value setting, the second predetermined vehicle speed being higher than the first predetermined vehicle speed.

11. The vehicle speed control device as set forth in claim 4, wherein:
the drive circuit has an electric power supply upper limit value setting as to an electric power that the drive circuit is capable of supplying to the electric motor; and
the vehicle speed control device performs a third judgment as to whether or not the traction battery is in a predetermined low remaining charge state in which the traction battery has more remaining charge than in the battery just before died state, and if it is determined in the third judgment that the traction battery is in the predetermined low remaining charge state, controls the electric motor to restrict vehicle speed to a second predetermined vehicle speed or to a lower speed by reducing the electric power supply upper limit value setting, the second predetermined vehicle speed being higher than the first predetermined vehicle speed.

12. A vehicle, comprising a vehicle speed control device as set forth in claim 2.

13. A vehicle, comprising a vehicle speed control device as set forth in claim 3.

14. A vehicle, comprising a vehicle speed control device as set forth in claim 4.

15. A vehicle, comprising a vehicle speed control device as set forth in claim 5.

16. A vehicle, comprising a vehicle speed control device as set forth in claim 6.

17. A vehicle, comprising a vehicle speed control device as set forth in claim 7.
